(19) United States
(12) Patent Application Publication
(10) Pub. No.: US 2026/0311266 A1
(43) Pub. Date: Oct. 8, 2026

(54) AI-Based Payroll Processing Platform

(71) Applicant: Intermezzo Inc., Menlo Park, CA (US)

(72) Inventors: Kumar Ramanathan, Sunnyvale, CA (US); Siddharth Ram, Menlo Park, CA (US)

(73) Assignee: Intermezzo Inc., Menlo Park, CA (US)

(21) Appl. No.: 19/256,702

(22) Filed: Jul. 1, 2025

Related U.S. Application Data
(60) Provisional application No. 63/784,905, filed on Apr. 7, 2025.

(51) Int. Cl. G06Q 40/12; G06Q 10/105; G06F 40/40

(52) U.S. Cl. CPC G06Q 40/125; G06Q 10/105; G06Q 40/123; G06F 40/40

(57) ABSTRACT

Systems and methods, described herein, are configured to perform Artificial Intelligence (AI) based operations for managing payroll processing. An automated method, according to one implementation, includes a step of harvesting employee-related information from multiple sources, wherein the employee-related information includes time records, compensation data, and regulatory information with respect to an employee. The method also includes a step of extracting payroll data from the employee-related information using a knowledge extraction engine that employs a Large Language Model (LLM). Furthermore, the method includes a step of validating the payroll data through multiple validation agents. Based on the payroll data, the method also includes automatically generating and filing tax schedules and payments to one or more regulatory agencies using a tax filing engine.

### CROSS REFERENCE TO RELATED APPLICATION

The present application claims the benefit of priority to U.S. Provisional Patent Application No. 63/784,905, filed Apr. 7, 2025, entitled “AI-Based Payroll Processing Platform,” the contents of which are incorporated by reference herein.

### TECHNICAL FIELD

The present disclosure relates generally to computing and artificial intelligence (AI). More particularly, the present disclosure relates to systems and methods for an AI-based global payroll platform.

### BACKGROUND

Payroll processing is a critical function within human capital management (HCM), integral to businesses in the United States and globally. Despite its importance, payroll technology often lags behind modern advancements, relying heavily on legacy systems and manual processes. Typically, payroll tasks are handled by back-office staff who manually perform calculations, verify time records, manage compliance with regulatory requirements, and submit tax filings. This manual-intensive approach remains prevalent domestically and is even more pronounced internationally, given varied regional regulations and less digitized systems. Core payroll capabilities—including time and attendance management, gross-to-net salary calculations, regulatory compliance, and tax filing—are predominantly controlled by a limited number of large, incumbent vendors. These vendors often provide legacy systems characterized by fragmented solutions that do not seamlessly integrate with broader human capital management platforms or third-party tools. As a result, payroll processing frequently involves multiple standalone products, creating data silos and causing significant friction points.

This fragmentation and reliance on outdated technology creates numerous operational inefficiencies, inaccuracies, and compliance risks, generating considerable frustration across the payroll ecosystem. Employers grapple with complexity, high administrative costs, and exposure to compliance errors. Employees often experience delays or errors in pay and benefits processing, negatively impacting their experience and satisfaction. Payroll vendors themselves face pressure to support disparate systems, maintain complex integrations, and address continuous regulatory changes, all of which contribute to operational strain and customer dissatisfaction. Consequently, there is a clear and urgent need for modernized, integrated payroll solutions that leverage automation, real-time data synchronization, and intuitive user experiences to address these pervasive challenges and improve outcomes for all stakeholders involved in the payroll process.

### BRIEF SUMMARY

The present disclosure describes systems and methods for performing automated payroll processing operations. In one implementation, a method includes a step of harvesting employee-related information from multiple sources, wherein the employee-related information includes time records, compensation data, and regulatory information with respect to an employee. Also, the method includes a step of extracting payroll data from the employee-related information using a knowledge extraction engine that employs a Large Language Model (LLM). The method further includes a step of validating the payroll data through multiple validation agents. Based on the payroll data, the method also includes a step of automatically generating and filing tax schedules and payments to one or more regulatory agencies using a tax filing engine.

In some embodiments, the multiple validation agents may include a) an Artificial Intelligence (AI) completeness agent that ensures extracted payroll data includes regulatory details for compliance, b) an LLM judge agent that evaluates the logical consistency and accuracy of structured payroll data extracted from natural language regulatory inputs by employing semantic accuracy evaluation, and/or c) a domain-expert agent. Also, in some implementations, the method may further include steps of a) converting the time records to a gross compensation amount using a time-to-gross engine, and b) refining the gross compensation amount to a net amount based on employee-specific deductions using a gross-to-net engine.

The method, in some embodiments, may also include steps of a) generating a computational state graph from the validated structured payroll data, and b) executing deterministic payroll calculations using the computational state graph to determine gross pay, applicable taxes, deductions, and net pay. Furthermore, the method may include enabling user interactions through a Natural Language Processing (NLP) LLM interface configured to answer payroll-related queries by retracing stages in the computational state graph. According to some embodiments, the method may further include a step of performing automated verification of payroll calculations using a constraint verification algorithm integrated within the computational state graph. The computational state graph, for example, may include nodes representing sequential payroll calculation procedures including one or more of a) gross pay determination, b) deduction computations, and c) net pay calculations.

According to some implementations, the payroll-related data may include multilingual regulatory documents and global procedural texts to manage payroll regulations based on a location of the employee and a location of an employer. In some embodiments, the method may further include a step of providing real-time updates to one or more of a) the knowledge extraction engine, b) the LLM, and c) the multiple validation agents in response to detected changes in regulatory compliance requirements. The step of validating the payroll data, for instance, may further include human feedback using a Reinforcement Learning with Human Feedback (RLHF) agent to enhance AI model accuracy and reliability.

The step of automatically generating and filing tax schedules and payments may also include determining tax obligations at local, state, and federal jurisdictional levels based on executed deterministic payroll calculations. In some embodiments, the method may also include a step of integrating payroll calculations and outcomes into an HR operations platform interconnected with modules for time tracking, absence management, onboarding, offboarding, and benefits management. Also, the method, in some embodiments, may include a step of automatically alerting stakeholders to payroll data changes and regulatory updates via notification agents. The employee-related information, according to some implementations, may be harvested from employee portals, employer portals, and partner portals via standardized Application Programming Interfaces (APIs). Furthermore, the method may also include a step of continuously refining AI agent performance through iterative feedback loops involving automated agents and human reviewers.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 illustrates an Employee Lifecycle, encompassing Human Capital Management (HCM) activities, according to various embodiments.

FIG. 2 is a flow diagram illustrating payroll processing steps, highlighting human intervention, according to various embodiments.

FIG. 3 is a block diagram illustrating a computing system that enables payroll processing functionality, according to various embodiments.

FIG. 4 illustrates a block diagram of an AI-based payroll processing platform, emphasizing automation and advanced data management, according to various embodiments.

FIG. 5 illustrates a detailed layered diagram illustrating the functional architecture of the AI-based payroll processing platform, emphasizing the structured approach of the system through three distinct, integrated layers, according to various embodiments.

FIG. 6 illustrates functional operation of a Knowledge Engine within the AI-based payroll processing platform, specifically highlighting the mechanism by which regulatory information is continuously monitored, validated, and updated, according to various embodiments.

FIG. 7 illustrates a detailed functional diagram of a Gross-to-Net Engine within the AI-based payroll processing platform, according to various embodiments.

FIG. 8 illustrates a detailed functional diagram of the Tax Filing Engine within the AI-based payroll processing platform, highlighting automated generation and transfer of tax schedules and payments to regulatory agencies, according to various embodiments.

FIG. 9 illustrates an architectural diagram of the AI-based, API-first payroll processing platform, emphasizing the integration of advanced artificial intelligence, robust APIs, and comprehensive compliance mechanisms, according to various embodiments.

FIG. 10 illustrates a comprehensive functional diagram of the AI-based payroll platform, emphasizing its API-driven architecture, robust integration capabilities, strategic partnerships, and modern technology stack, according to various embodiments.

FIG. 11 is a flow diagram illustrating a method for performing payroll processing activities, according to various embodiments.

FIG. 12 is a diagram illustrating an embodiment of an HR system having an HR Operations Platform serving as a unified hub that orchestrates multiple operational functionalities essential to comprehensive human capital management, according to various embodiments.

FIG. 13 is a flow diagram illustrating an automated method for performing payroll processing operations, according to various embodiments.

### DETAILED DESCRIPTION

To address these challenges, the present disclosure provides an innovative payroll platform leveraging AI. This platform is designed as a global solution rather than being limited to any single country or region, aiming to efficiently manage payroll operations across most major countries. One of the main objectives is to significantly redesign and improve the payroll industry, characterized by traditionally low Net Promoter Scores (NPS) and operational burdens, by creating a streamlined, unified, and highly integrated global HR operations platform for payroll. By utilizing AI-driven automation, real-time data synchronization, and a user-centric design, the systems and methods of the present disclosure aim to simplify payroll processes, enhance accuracy and compliance, and dramatically improve satisfaction for employers, employees, and payroll vendors alike.

### Employee Lifecycle

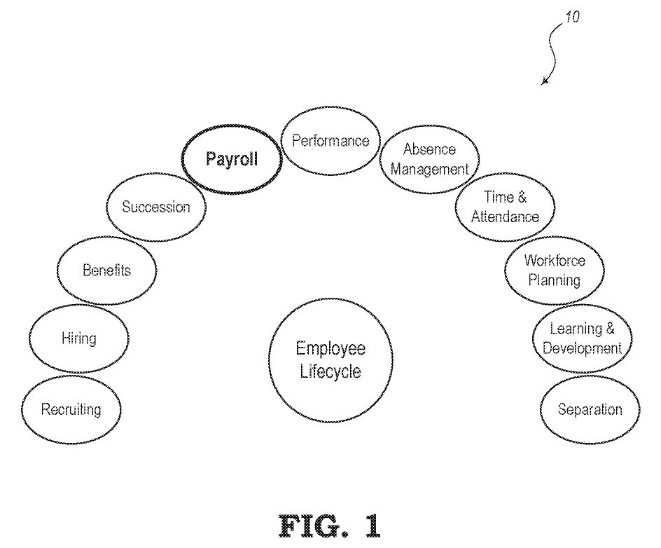

FIG. 1 illustrates an embodiment of an Employee Lifecycle 10, encompassing Human Capital Management (HCM) activities arranged in an arc around a central circle labeled "Employee Lifecycle." The components of the Employee Lifecycle 10 include Recruiting, Hiring, Benefits, Succession, Payroll, Performance, Absence Management, Time & Attendance, Workforce Planning, Learning & Development, and Separation. Each component may be represented by a distinct icon and color to emphasize the interconnected, yet distinct functions involved in managing employee experiences from entry to exit within an organization.

Focusing specifically on Payroll, Payroll may be viewed as one of the central activities within the Employee Lifecycle 10. This placement underscores the payroll’s pivotal role in HCM, emphasizing its foundational importance. Despite its centrality, payroll management faces substantial operational challenges. These include manual calculations, complex compliance requirements across different jurisdictions, fragmented solutions, and difficulties integrating with other HCM components such as Time & Attendance, Benefits, and Performance Management. These challenges contribute significantly to operational inefficiencies and dissatisfaction among employers, employees, and payroll vendors, further illustrating the need for innovative and integrated payroll solutions. The embodiments of the present disclosure are configured to overcome some or all of these shortcomings.

Payroll issues may consistently cause significant operational strain and dissatisfaction among payroll providers, employers, and employees alike. Common payroll problems include frequent overpayments, missed payments, inaccuracies in compensation, incorrect tax deductions, delayed reimbursements, and other errors impacting financial accuracy and compliance. These persistent issues not only frustrate employees—damaging their trust and engagement—but also increase administrative costs and risks for employers and payroll service providers.

Recent industry surveys indicate that Chief Information Officers (CIOs) are increasingly prioritizing improvements in payroll operational efficiency, recognizing payroll processing as a critical area for optimization. The heightened attention reflects a strategic shift toward investing in technology-driven solutions, including advanced automation, integrated platforms, and AI-driven systems, aimed at minimizing payroll errors, enhancing compliance, and ultimately improving the employee experience.

Additionally, there are several critical considerations for C-suite executives, including CIOs, Chief Financial Officers (CFOs), and Chief Human Resources Officers (CHROs). These include maintaining strategic flexibility to expand globally while hiring locally within international markets. Moreover, there is an increasing demand for continuous payroll processing and earned wage access capabilities, which is essential for attracting and retaining talent in highly competitive labor environments. Finally, executives must prioritize reducing payroll operation costs by innovatively leveraging advanced technology solutions.

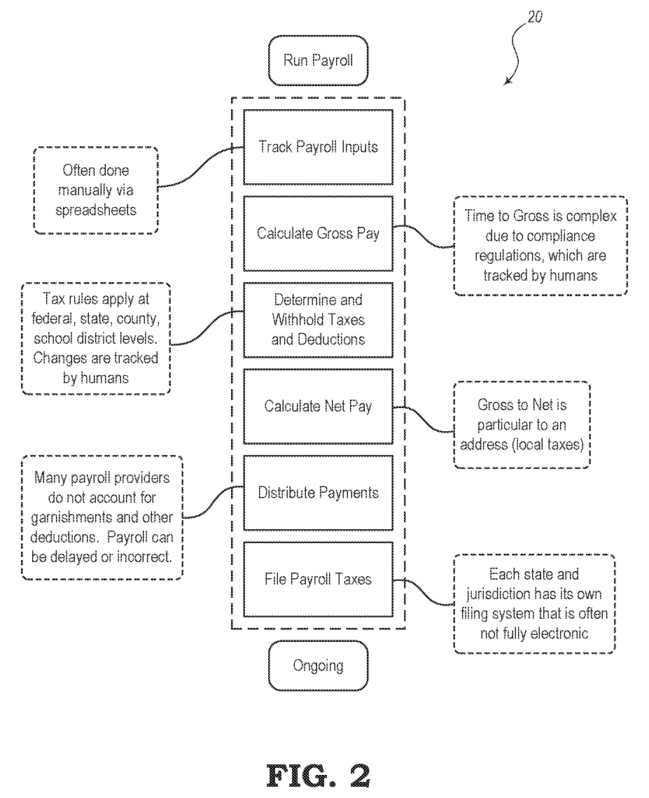

FIG. 2 is a diagram illustrating a process 20 for performing traditional payroll processing steps, highlighting extensive human intervention, which may typically render payroll operations costly, slow, and susceptible to errors. The process 20 of FIG. 2 shows a sequential workflow labeled "Run Payroll," encompassing multiple critical activities:
(1) Track Payroll Inputs: This step often involves manual data entry via spreadsheets, making the initial stage labor-intensive and prone to human error.
(2) Calculate Gross Pay: This calculation, known as "time to gross," is particularly complex due to varying compliance requirements across jurisdictions. Such complexity necessitates significant manual oversight, increasing potential inaccuracies.
(3) Determine and Withhold Taxes and Deductions: Payroll taxes involve multilayered rules applied at federal, state, county, and even school district levels. Tracking and adjusting for regulatory changes typically rely on manual updates, further elevating the risk of non-compliance or errors.
(4) Calculate Net Pay: The "gross-to-net" calculation step frequently involves local or address-specific tax considerations, demanding precise attention from payroll administrators and increasing the likelihood of miscalculations.
(5) Distribute Payments: Payment distribution processes are often complicated by garnishments, court-ordered deductions, and other special circumstances. Many existing payroll providers lack automated mechanisms to reliably account for these deductions, frequently resulting in delayed or incorrect employee payments.
(6) File Payroll Taxes: Finally, tax filing involves interactions with multiple state and jurisdictional filing systems, many of which are not fully digitized. This lack of electronic integration requires substantial manual intervention, elevating administrative burdens and compliance risks.

The process 20 also includes ongoing, continuous payroll management activities and underscores the inefficiencies inherent to traditional payroll operations. FIG. 2 makes clear the operational need for technology-driven solutions to minimize manual inputs, streamline payroll workflows, and improve accuracy and compliance.

### General-Purpose Computer

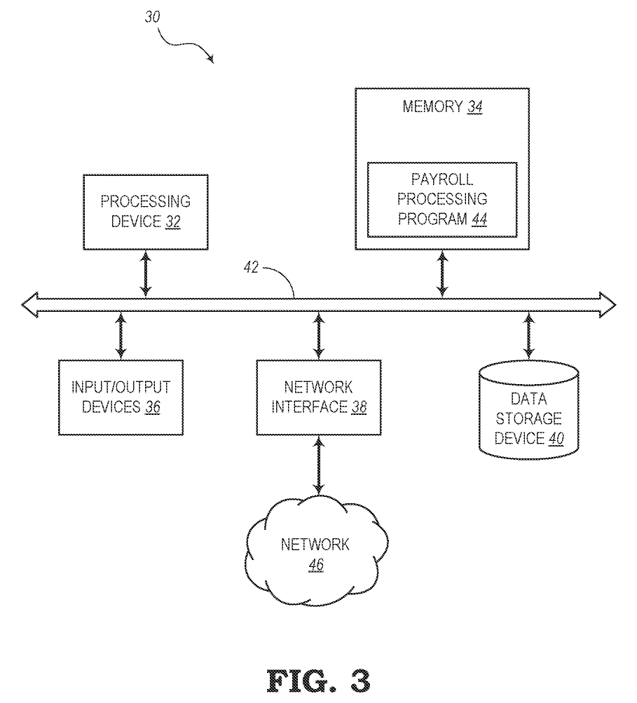

FIG. 3 is a block diagram illustrating an embodiment of a computing system 30 that enables payroll processing functionality according to the embodiments of the present disclosure. As shown in simplified form, the computing system 30 includes a processing device 32, memory 34, Input/Output (I/O) devices 36, a network interface 38, and a data storage device 40, all communicatively coupled via a local interface 42.

The processing device 32 may include one or more processors, such as a Central Processing Unit (CPU), and may further include or be coupled to one or more specialized processing units, such as a Graphics Processing Unit (GPU), a Digital Signal Processor (DSP), a Network Processor (NP), a Field Programmable Gate Array (FPGA), and/or an Application-Specific Integrated Circuit (ASIC). The processing device 32 is configured to execute software instructions and manage operations of the computing system 30, including coordinating communication across components via the local interface 42. In some embodiments, the processing device 32 may implement logic through software, firmware, hardware, or any combination thereof, and may be characterized as “circuitry configured to” perform certain functions.

The memory 34 may include any combination of volatile and non-volatile memory technologies, such as Random Access Memory (RAM), Dynamic RAM (DRAM), Synchronous DRAM (SDRAM), Static RAM (SRAM), Read-Only Memory (ROM), Programmable Read-Only Memory (PROM), Erasable Programmable Read-Only Memory (EPROM), Electrically Erasable Programmable Read-Only Memory (EEPROM), flash memory, etc. The memory 34 stores operating system software, application programs, data, and other executable instructions. In some implementations, the memory 34 may be distributed or hierarchically organized and accessed by the processing device 32 over the local interface 42. The memory 34 may also include a cache, buffers, or a memory management unit.

The Input/Output (I/O) devices 36 facilitate user interaction and system integration, and may include input devices such as keyboards, mice, touchscreens, and microphones, as well as output devices such as displays, printers, speakers, and haptic interfaces. The I/O devices 36 may also include peripheral sensors (e.g., biometric scanners, cameras), and may be directly connected to or communicate wirelessly with the computing system 30, including via the network interface 38.

The network interface 38 enables the computing system 30 to communicate with external networks, such as network 46, the Internet, a local area network (LAN), or a wide area network (WAN). The network interface 38 may include wired or wireless interfaces (e.g., Ethernet, Wi-Fi, Bluetooth) and support various protocols including TCP/IP, UDP, and others. It may include built-in security mechanisms such as encryption, firewalls, or authentication features, and may be implemented as an integrated or discrete module.

The data storage device 40 provides persistent storage for digital information and may include a Hard Disk Drive (HDD), Solid-State Drive (SSD), and/or other non-volatile storage technology. In some embodiments, the data storage device 40 may function as a database or be coupled to an external data store, supporting efficient retrieval, indexing, and management of data. The data storage device 40 may be local to the system or remotely accessible via the network interface 38.

The local interface 42, also referred to as a bus interface, provides the communication backbone for data exchange among components. It may include one or more buses or communication channels, such as a memory bus, I/O bus, or system bus, and may conform to protocols such as PCI, USB, AMBA, or others. The local interface 42 may also include address, data, and control lines, and additional circuitry such as buffers, repeaters, or controllers to ensure efficient and synchronized operation of the system.

In operation, the processing device 32 executes instructions from the memory 34, exchanges data with the I/O devices 36, communicates externally via the network interface 38, retrieves and stores persistent data on the data storage device 40, and coordinates all component interactions over the local interface 42 to implement the described functionality.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions described in the present disclosure. Such non-transitory computer-readable storage mediums can include, but are not limited to, hard disks, optical storage devices, magnetic storage devices, ROM, PROM, EPROM, EEPROM, flash memory, etc. The software stored in these media includes executable instructions that, upon execution by one or more processors or any programmable circuitry, enable, cause, or instruct the processor or circuitry to undertake a series of operations, steps, methods, processes, algorithms, functions, or techniques as detailed herein for the various embodiments.

Also, the computing system 30 includes a payroll processing program 44, which may be implemented in any suitable combination of hardware (e.g., in the processing device 32) and/or software or firmware (e.g., in the memory 34 or other non-transitory computer-readable media). The payroll processing program 44 is configured to execute various functions as described herein for improving conventional systems, thereby simplifying the tasks for human operators, reducing errors, etc.

### AI-based Payroll Platforms

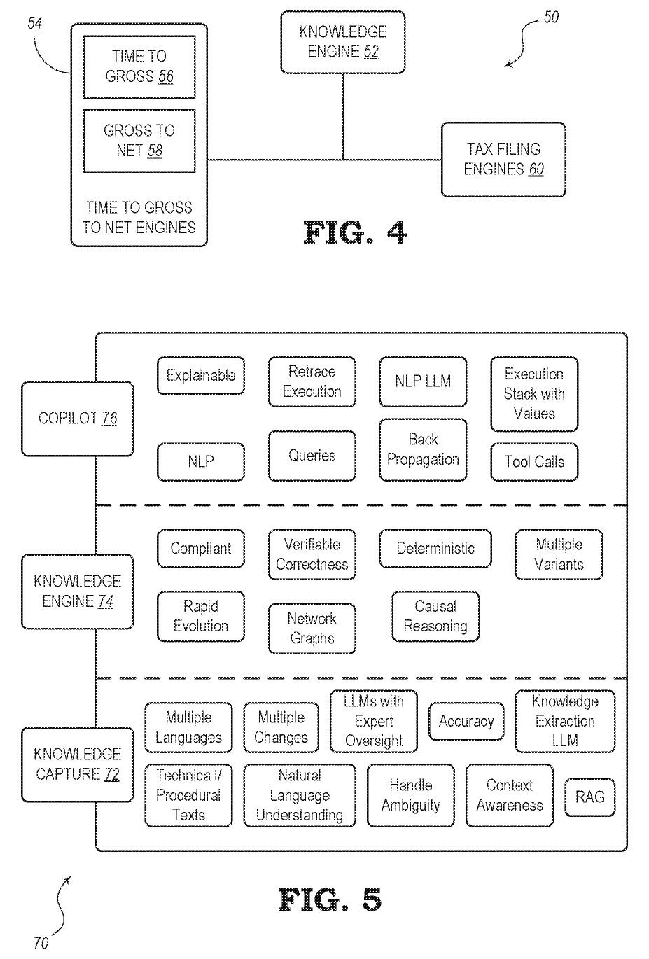

FIG. 4 illustrates a block diagram of an AI-based payroll processing platform 50, emphasizing automation and advanced data management. In some embodiments, the AI-based payroll processing platform 50 may be configured as part of the payroll processing program 44 shown in FIG. 3. The AI-based payroll processing platform 50 includes a Knowledge Engine 52, which employs multiple intelligent agents designed to systematically discover, aggregate, and structure diverse payroll-related data. This knowledge harvesting process involves automatically gathering and organizing relevant inputs such as employee hours, compensation details (including commissions, overtime, and sick leave), regulatory updates, and tax information, making it readily consumable by downstream processes. The AI-based payroll processing platform 50 also includes time-to-gross-to-net engines, which include a time-to-gross engine 56 and a gross-to-net engine 58. Furthermore, the AI-based payroll processing platform 50 includes tax filing engines 60.

The structured data from the Knowledge Engine 52 feeds into specialized computational engines:
(1) Time to Gross Engine 56: This engine initially receives and processes raw time data inputs such as regular work hours, overtime, commissions, bonuses, and various forms of leave (e.g., sick pay, vacation time). It accurately converts these diverse payroll inputs into a gross compensation amount, ensuring full compliance with local labor regulations and employment contracts.
(2) Gross to Net Engine 58: Once the gross salary has been calculated, the Gross to Net Engine further refines this calculation. It systematically accounts for all employee-specific deductions, including both pre-tax contributions (e.g., retirement accounts, health insurance) and post-tax deductions (e.g., wage garnishments). This engine meticulously incorporates local, state, and federal tax obligations relevant to the geographical location of both the employee and employer, resulting in precise net salary figures ready for distribution.
(3) Tax Filing Engines: Following accurate net-pay calculations, automated tax filing engines generate contextualized tax schedules and filings. These engines automatically compute amounts owed and facilitate the timely submission of required payments and documentation to federal, state, and local tax regulatory agencies, significantly reducing administrative overhead and minimizing compliance risks.

Together, these interconnected components of the AI-based payroll processing platform 50 leverage artificial intelligence to streamline the payroll process end-to-end, enhancing efficiency, accuracy, compliance, and overall satisfaction across payroll stakeholders.

FIG. 5 illustrates an embodiment of a layered system 70 and shows the functional architecture of the AI-based payroll processing platform 50 of FIG. 4 and/or other payroll processing systems, emphasizing the structured approach of the layered system 70 through three distinct, integrated layers:
(1) Knowledge Capture Layer 72 (Bottom Layer): This foundational layer leverages advanced Large Language Models (LLMs) enhanced by expert oversight to interpret and capture complex, multilingual inputs, including technical and procedural payroll texts. Key capabilities of this layer include robust natural language understanding (NLU), the ability to handle ambiguity, context-awareness, and adaptability to frequent changes in payroll-related regulations and procedures. Intelligent agents within this layer convert the captured payroll information into structured representations, specifically state machines, facilitating accurate interpretation and standardization of diverse input sources.
(2) Knowledge Engine Layer 74 (Middle Layer): Building upon the structured information captured by the bottom layer, the Knowledge Engine employs deterministic computational methodologies, primarily through sophisticated network graphs, to execute the previously constructed state machines. This layer ensures compliance, deterministic calculations, verifiable correctness, and thorough testing. The deterministic nature of this layer allows for precise, causal reasoning, enabling the handling of multiple variants and rapid adaptation to evolving regulatory and organizational contexts. By transforming probabilistic inputs into deterministic outputs, this layer delivers consistent, accurate payroll computations.
(3) Copilot Interaction Layer 76 (Top Layer): At the highest level, the Copilot layer utilizes natural language processing (NLP)-enabled LLMs to provide transparent, user-friendly interaction. A unique feature of this layer is its capability to deliver detailed explanations for specific payroll queries, such as clearly answering employee inquiries like, “Why was $131.21 deducted from my paycheck for FICA?” This top layer, through advanced retrace execution capabilities, can precisely detail the step-by-step computational and regulatory logic that led to specific payroll outcomes. This explanatory capability surpasses current market standards by providing unprecedented transparency and clarity to users regarding payroll-related questions.

Collectively, these three layers form what is termed an "LLM sandwich," seamlessly integrating probabilistic interpretation at the bottom, deterministic computational execution in the middle, and probabilistic yet highly explainable user interactions at the top, enabling a robust, transparent, and highly accurate AI-based payroll processing platform.

In addition, the layered system 70 of FIG. 5 illustrates more in-depth functional architecture of the AI-based payroll processing platform 50. Furthermore, the layered system 70 delineates explicit interactions and internal mechanisms across the three distinct, interconnected layers of the system:

(1) Knowledge Capture Layer 72: The foundational layer in FIG. 5 expands on knowledge extraction capabilities utilizing a sophisticated multi-agent system incorporating advanced Large Language Models (LLMs). This layer continuously monitors primary data sources through Retrieval-Augmented Generation (RAG), incorporates structured data extraction, performs self-validation, and leverages tool calls for enhanced accuracy.

An essential innovation highlighted here is the integration of “Multiple Critics,” advanced agent-based critique mechanisms including an LLM-based judge and domain-specific experts. These critics assess the extracted information for accuracy, completeness, and contextual appropriateness, and they signal any disagreements or gaps that require correction. Crucially, this layer also includes a human-in-the-loop component, employing Reinforcement Learning with Human Feedback (RLHF), recognizing the need for nuanced human judgment to refine the system's outputs. This combined human-agent critic approach addresses the complexity, ambiguity, and variability inherent in payroll data, ensuring high-quality structured outputs.

In addition to jurisdiction specific structured information, this knowledge capture layer is able to analyze company specific policies and any collective bargaining agreements with unions or other employee organizations, to dynamically customize the state machine to meet the obligations outlined in these documents.

(2) Knowledge Engine Layer 74: The middle layer serves as the primary computational and runtime engine of the payroll platform. Explicitly depicted are “Network Graphs,” which represent deterministic computational state machines derived from structured inputs provided by the Knowledge Capture Layer. This layer is entirely non-probabilistic and non-LLM based, operating via computational graph logic to maintain determinism and reliability. Additionally, this layer employs a Constraint Verification Algorithm, meticulously validating computations for compliance and correctness against predefined business rules and payroll regulations. The deterministic nature of this layer assures precise, reproducible, and verifiable payroll computations, critical for regulatory compliance and operational integrity.

(3) Copilot Interaction Layer 76: At the highest level, the Copilot layer returns to an LLM-based model, designed for sophisticated user interaction. This layer employs an NLP-based Large Language Model (LLM) integrated with tool-calling capabilities and maintains a comprehensive execution stack with detailed values. Crucially, it utilizes a powerful Back-Propagation method, enabling the LLM to systematically retrace the execution paths through the network graphs. This functionality provides users with transparent, detailed explanations, allowing them to clearly understand the computational logic behind specific payroll outcomes or deductions. By effectively walking backwards through the computational graphs, this top layer delivers unmatched transparency and insight into the payroll decision-making process, thus significantly enhancing user trust and satisfaction.

Collectively, FIG. 5 elaborates on the robust, integrated, and layered nature of the AI-driven payroll platform, clearly delineating the critical roles of probabilistic, deterministic, and explanatory mechanisms within a coherent, highly effective computational structure.

### Knowledge Engine

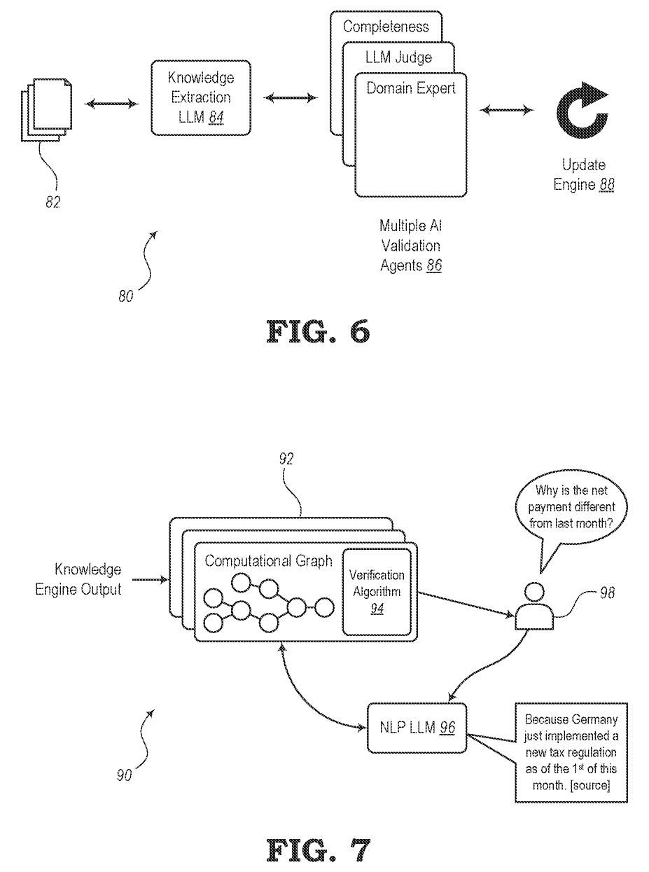

FIG. 6 illustrates an embodiment of the functional operations of a Knowledge Engine 80 (e.g., Knowledge Engine 52, 74, etc.) within the AI-based payroll processing platforms and layered systems, specifically highlighting the rigorous mechanism by which regulatory information is continuously monitored, validated, and updated. AI may constantly monitor changing regulations and may update upon agent agreement. The figure depicts a sequential workflow emphasizing accuracy and reliability:
(1) Regulatory Data Sources: On the left side of FIG. 6, regulatory documents and updates 82 are collected from various sources. These regulatory documents and updates 82 encompass multiple languages, reflecting the international scope of payroll operations. The inputs are also technical and procedural in nature, emphasizing the complexity and precision required in payroll compliance. Notably, these regulatory inputs are constantly changing, necessitating continuous monitoring.
(2) Knowledge Extraction LLM 84: The next component involves a sophisticated Large Language Model (LLM) dedicated to knowledge extraction. This LLM systematically processes the diverse regulatory inputs, translating complex and multilingual regulatory documentation into structured, standardized formats suitable for computational analysis. It ensures rapid and consistent integration of regulatory updates into the payroll platform.
(3) Multiple AI Validation Agents 86: To ensure maximal accuracy, the structured outputs from the Knowledge Extraction LLM 84 are rigorously evaluated by multiple specialized AI, mathematical, and human expert agents:
   (a) Completeness Agent: Validates that all necessary regulatory details have been captured and no critical information has been omitted.
   (b) LLM Judge: Employs an advanced LLM to critically assess the logical consistency and correctness of the extracted knowledge, ensuring semantic accuracy and contextual appropriateness.
   (c) Domain Expert Agent: Simulates the role of a human expert, applying deep domain-specific knowledge to verify the regulatory information for practical applicability and compliance accuracy. These validation agents collaboratively review, critique, and refine extracted knowledge, establishing consensus through multi-agent agreement before approval.
(4) Update Engine 88: Upon achieving validation consensus, confirmed updates are transmitted to the Update Engine 88. This component automatically incorporates validated regulatory changes into the payroll platform's Knowledge Engine, ensuring that all computational operations and payroll decisions reflect the most current and accurate regulatory compliance requirements.

Together, these components create a robust, self-validating feedback loop, continuously refining and updating the knowledge base underpinning payroll operations, thus ensuring ongoing compliance, accuracy, and reliability.

### Gross to Net Engine

FIG. 7 illustrates a detailed functional diagram of a Gross-to-Net Engine 90 (e.g., gross-to-net engine 58) within the AI-based payroll processing platform. The diagram specifically emphasizes how computational graphs 92 deterministically perform payroll calculations and enable comprehensive query and explanation capabilities.
(1) Knowledge Engine Output: On the left side, FIG. 7 depicts structured payroll knowledge outputs derived from the platform’s Knowledge Engine (e.g., Knowledge Engine 52, 74) described above. These outputs encapsulate payroll rules, regulations, tax information, and deduction guidelines. The Knowledge Engine 90 ensures these outputs are consistently compliant, verifiably correct through rigorous validation processes, and constantly updated to reflect the latest regulatory and operational standards.
(2) Computational Graph 92: At the center of FIG. 7, computational graphs 92 receive structured data from the Knowledge Engine 90. These graphs represent deterministic payroll calculations, executing precise and transparent computations from gross salary figures to final net pay. Each node within the computational graph 92 denotes a specific calculation step (e.g., tax deductions, pre-tax contributions, post-tax adjustments), clearly illustrating the sequential and dependent relationships between these payroll calculation steps. The graph supports conditional flows through branching, composition through recursive execution of graphs & sub-graphs, support for multiple versions based on effective dates & company-specific policies and automated execution tracking by registering visited nodes during execution.
(3) Verification Algorithm 94: Embedded within the computational graph 92 structure is a Verification Algorithm 94. This algorithm systematically verifies each calculation step, ensuring every node and computational pathway adheres strictly to predefined payroll rules and regulatory constraints. This rigorous verification mechanism guarantees accuracy, compliance, and reliability of payroll outcomes.
(4) Natural Language Processing (NLP) LLM 96: The gross-to-net engine 58 of FIG. 7 further introduces an NLP-based Large Language Model (LLM) 96 designed to provide interactive query and explanation capabilities. Users 98, such as employees or payroll administrators, can pose detailed, natural-language questions (e.g., “Why is the net pay different from last month?”). The NLP engine interacts seamlessly with the computational graphs 92, enabling it to accurately retrace calculation steps and offer clear, contextualized explanations. For example, the LLM might explain variations in net pay by pointing to recent regulatory changes, explicitly stating reasons such as, "Because Germany just implemented a new tax regulation as of the 1st of this month."

This integration of deterministic computational graphs with advanced NLP-based query capabilities provides unparalleled transparency, accuracy, and responsiveness in payroll processing. Employees and employers alike benefit from a precise understanding of payroll computations, fostering trust and satisfaction across all payroll stakeholders.

### Tax Filing Engine

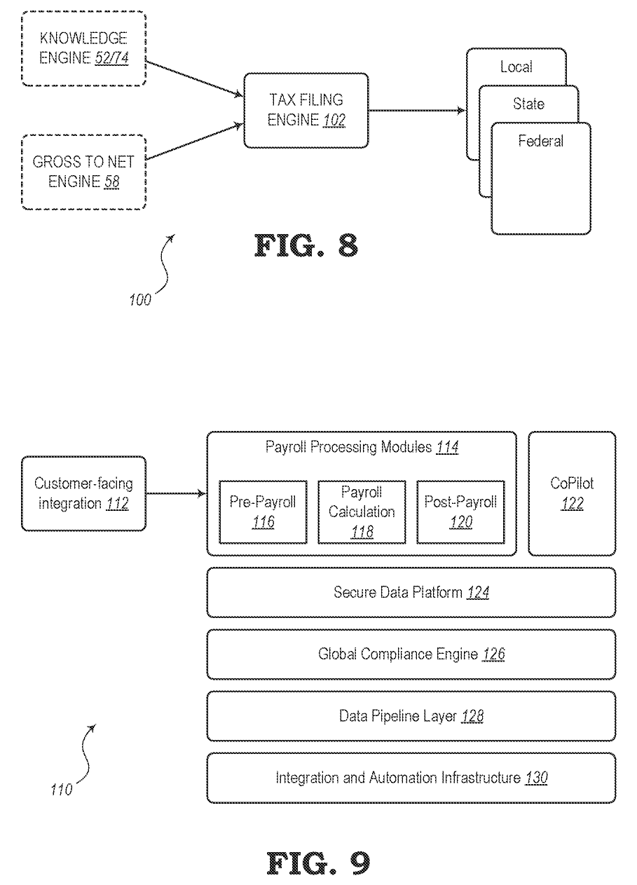

FIG. 8 illustrates an embodiment of a detailed functional diagram of a system 100 using a Tax Filing Engine 102 within the AI-based payroll processing platform, highlighting automated generation and transfer of tax schedules and payments to regulatory agencies. In some embodiments, the Tax Filing Engine 102 may be the same or similar to the tax filing engines 60 described with respect to FIG. 4.
(1) Inputs from Knowledge Engine 52/74/90 and Gross-to-Net Engine 58: On the left side of FIG. 8, the Knowledge Engine 52/74/90 and the Gross-to-Net Engine 58 provide structured inputs. The Knowledge Engine contributes continuously updated, verified regulatory information, including accurate tax rates, jurisdiction-specific requirements, filing schedules, and compliance guidelines. The Gross-to-Net Engine supplies finalized, verified payroll calculation results, detailing employee net pay, applicable taxes, deductions, and liabilities.
(2) Tax Filing Engine 102: At the center, the Tax Filing Engine 102 systematically integrates the inputs from both engines to generate comprehensive tax filing schedules. This engine automates preparation and submission processes, calculating precise tax obligations across multiple regulatory levels, including local, state, and federal jurisdictions. The Tax Filing Engine 102 ensures accurate tax calculations, applies jurisdiction-specific rules automatically, schedules timely payments, and prepares complete filing documentation, significantly reducing the potential for human error and non-compliance.
(3) Automated Regulatory Submission: On the right, FIG. 8 shows the automatic transfer of generated tax schedules and payments directly to relevant regulatory agencies—clearly categorized into Local, State, and Federal entities. This automated process ensures timely, accurate, and compliant submissions to all appropriate government bodies, facilitating seamless regulatory compliance and minimizing administrative burdens. Regulatory filings requirements vary based on jurisdiction, size of payroll, number of employees, type of industry and a wide array of other parameters based on wage tax laws. These are automatically tracked and filed as needed for each payroll run, monthly, quarterly, and annually.

Overall, the system 100 of FIG. 8 emphasizes the seamless integration, automation, and efficiency enabled by the AI-based payroll platform's Tax Filing Engine 102, ensuring accuracy, compliance, and operational reliability while significantly streamlining the tax reporting process.

### Payroll Processing Architecture

FIG. 9 illustrates a detailed architectural diagram of an AI-based, API-first payroll processing platform 110, emphasizing the integration of advanced artificial intelligence, robust APIs, and comprehensive compliance mechanisms. The AI-based, API-first payroll processing platform 110 is organized into clearly defined functional components, underpinned by secure data management and dynamic, agentic compliance engines:
(1) Customer-Facing Integration 112: At the far left, FIG. 9 shows customer-facing integration 112 points enabled through APIs. This integration layer accepts various employee-specific data inputs including employee profiles (PII), compensation details, time cards, time-off, expense submissions, benefits enrollment, equity distributions, garnishments, and ad-hoc payroll adjustments. These data inputs are critical for accurate payroll processing and compliance management.
(2) Payroll Processing Modules 114: Centrally, the architecture is structured into three core processing modules:
   (a) Pre-Payroll Module 116: Handles initial payroll preparation tasks such as defining payroll policies, calendars, and deadlines. It includes automated input collection and thorough input validation, ensuring accuracy before payroll calculations commence.
   (b) Payroll Calculation Module 118: Performs critical payroll computations, including the calculation of employee gross earnings, deductions, taxes, and resulting net pay. This module leverages deterministic computational logic to maintain accuracy, compliance, and transparency in payroll processing.
   (c) Post-Payroll Module 120: Manages final payroll activities, including disbursement of payments, statutory tax filings, payroll accounting entries, and generation of detailed management reports. These processes ensure that payroll outcomes are correctly executed, documented, and auditable.
(3) CoPilot 122 (Interactive AI Module): To the right, the CoPilot 122 module provides advanced, AI-driven interactive guidance for both HR professionals and employees. Key features include HR compliance guidance, employee compliance insights, and detailed payroll analytics to enhance understanding and transparency of payroll outcomes.
(4) Supporting Layers and Capabilities: Below the primary modules, the diagram details the supporting layers and foundational capabilities of the platform:
   (a) Secure Data Platform 124: Offers robust data management within a multi-tenant environment, ensuring data security, integrity, scalability, and compliance across multiple customer organizations.
   (b) Global Compliance Engine 126: Incorporates advanced agentic AI mechanisms combined with reinforcement learning through human feedback (RLHF) to continuously update regulatory information, ensuring ongoing compliance across diverse global jurisdictions. This compliance engine is dynamic, accurate, and always current.
   (c) Data Pipeline Layer 128: Acts as a single-source repository providing compliant, verifiable, and auditable data flow between modules. The data pipeline is enhanced with expert-driven AI review (RLHF), ensuring ongoing accuracy and adaptability to regulatory changes.
   (d) Integration and Automation Infrastructure 130: At the bottom, robust technical infrastructure elements are depicted, including open APIs, extensive data connectors, comprehensive security and governance controls, and automation frameworks. This foundation ensures seamless integration, streamlined operations, and robust data management capabilities throughout the payroll platform.

Collectively, the AI-based, API-first payroll processing platform 110 of FIG. 9 conveys a highly integrated, AI-enhanced, API-first payroll platform designed to optimize payroll accuracy, compliance, efficiency, and user experience, fundamentally transforming traditional payroll operations through advanced automation, intelligent compliance management, and intuitive user interactions.

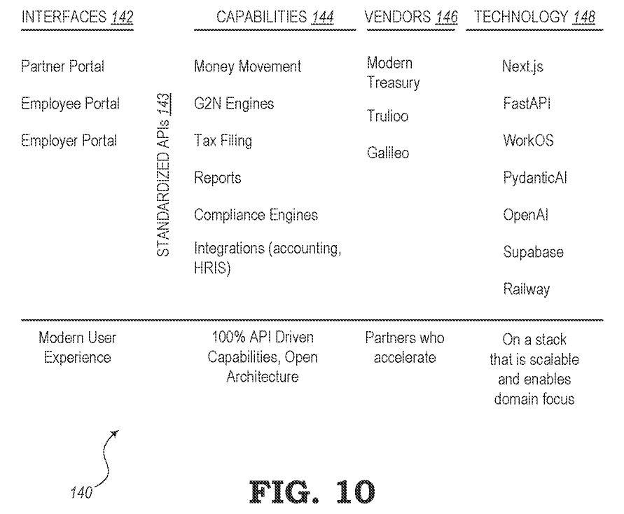

FIG. 10 illustrates a table 140 showing a functional diagram of the AI-based payroll platforms described in the present disclosure, emphasizing its API-driven architecture, robust integration capabilities, strategic partnerships, and modern technology stack. FIG. 10 is structured into distinct yet interconnected functional sections, demonstrating the platform’s breadth and flexibility:
(1) Interfaces 142 (Portals): At the left, the table 140 shows that the platform provides specialized portals designed for different stakeholders: Partner Portal: Allows seamless integration and interactions with external service partners. Employee Portal: Offers intuitive access for employees to view pay stubs, tax information, submit queries, and manage personal payroll details. Employer Portal: Facilitates employer-level tasks including payroll management, reporting, compliance oversight, and administrative controls. These interfaces collectively deliver a modern, intuitive user experience tailored to the needs of various platform users.
(2) Standardized APIs 143: Centrally positioned between sections, standardized APIs form the core connectivity backbone, enabling effortless data exchange, seamless integration, and interoperability with both internal components and external systems. These APIs underpin a fully open architecture and support comprehensive API-driven functionalities.
(3) Capabilities 144: The platform’s core functional capabilities include:
   (a) Money Movement: Automated handling of payroll disbursements, international payments, and real-time financial transactions.
   (b) Gross-to-Net (G2N) Engines: Robust, deterministic payroll computation engines accurately converting gross earnings to net pay considering multiple deductions and regulatory rules.
   (c) Tax Filing: Automated compliance with accurate generation, scheduling, and submission of local, state, and federal tax filings.
   (d) Reports: Comprehensive payroll reporting and analytics, supporting detailed operational insights and compliance audits.
   (e) Compliance Engines: Continuously updated compliance systems managing regulatory requirements globally and regionally.
   (f) Integrations (Accounting, HRIS): Seamless integrations with external systems, including accounting platforms and Human Resource Information Systems (HRIS), to ensure accurate data synchronization and streamlined workflows.
(4) Vendors 146 (Strategic Partners): To the right, the table 140 of FIG. 10 highlights strategic vendor relationships that extend the platform’s capabilities and accelerate its deployment: Modern Treasury: Enhances automated money movement and payment capabilities. Trulioo: Provides comprehensive identity verification and compliance solutions. Galileo: Facilitates seamless financial management and card-based transaction integrations. These strategic partnerships significantly accelerate the platform's operational readiness, scale, and effectiveness.
(5) Technology Stack 148: At the far right, the modern and robust technology stack underpinning the platform is showcased:
   Next.js: Enables scalable and performant web applications.
   FastAPI: Supports fast, efficient, and secure API-driven backend development.
   WorkOS: Simplifies enterprise-ready identity and access management.
   PydanticAl: Enhances structured data validation and Al integration.
   OpenAl: Provides powerful natural language processing and generative Al capabilities.
   Supabase: Delivers scalable, secure, and real-time backend database services.
   Railway: Offers robust, scalable infrastructure management and rapid deployment capabilities.

The integrated, modern technology stack as depicted in the table 140 ensures scalability, reliability, flexibility, and strong domain-focused capabilities, enabling rapid innovation and efficient operational management. Collectively, the table 140 of FIG. 10 highlights a highly integrated, API-first payroll platform architecture designed for flexibility, compliance, scalability, and modern user engagement, significantly transforming traditional payroll management through advanced technology and strategic partnerships.

### Payroll Workflow Operations

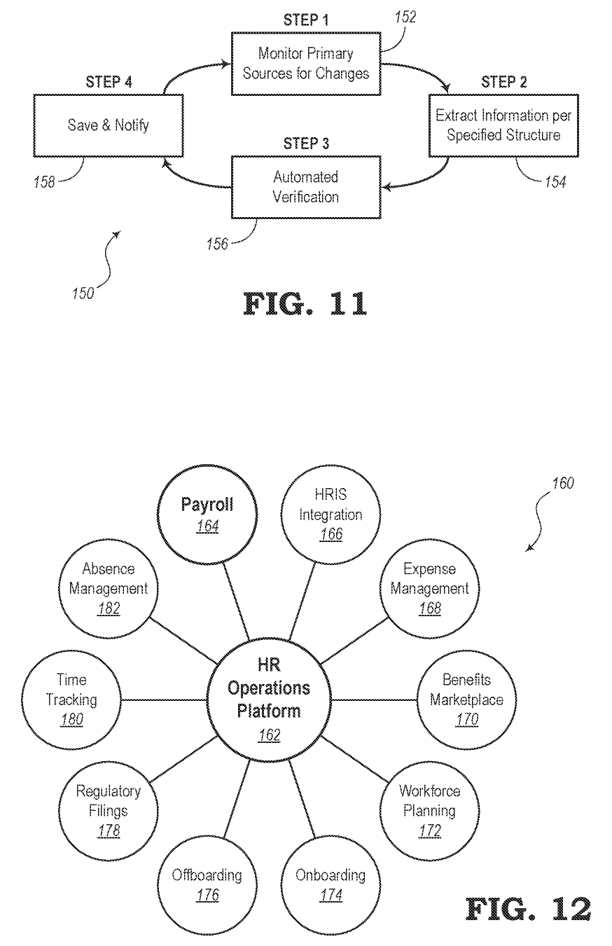

FIG. 11 illustrates an embodiment of a method 150 for executing a payroll workflow, demonstrating the rapid development and continuous refinement of payroll platform functionality using an advanced Agentic AI framework complemented by human-in-the-loop interaction via Reinforcement Learning with Human Feedback (RLHF). The method 150 of FIG. 11 highlights a cyclical, four-step automated process integrated with human validation:
Step 1 (block 152) – Monitor Primary Sources for Changes: AI-powered agents are configured to continuously monitor authoritative primary sources, such as regulatory updates, payroll laws, and procedural guidelines. This block 152 ensures the platform immediately identifies relevant changes in real-time, maintaining compliance and accuracy.
Step 2 (block 154) – Extract Information per Specified Structure: Once changes are detected, specialized AI agents systematically extract and structure the relevant information according to predefined schemas. This structured data ensures accurate, consistent interpretation and integration into the platform's computational models.
Step 3 (block 156) – Automated Verification: Extracted data is then rigorously validated by automated verification agents, employing AI-driven methods to verify accuracy, consistency, completeness, and adherence to regulatory compliance standards. This automated step rapidly identifies potential inaccuracies or inconsistencies, significantly enhancing reliability.
Step 4 (block 158) – Save & Notify: Verified and validated data is securely saved within the system’s data repository. Simultaneously, notification agents alert relevant stakeholders or subsequent processes about updates, ensuring seamless downstream processing and proactive user communication.

This cyclical agent-based workflow of the method 150 is augmented through explicit human-in-the-loop interactions (RLHF):

Validation UI (Human Validation): Human experts interact with a dedicated validation user interface, reviewing extracted and verified data. Humans provide critical feedback, corrections, or additional validations, which are subsequently fed back into the AI model to refine accuracy and performance continuously. This approach ensures the nuanced human judgment required for the highest levels of accuracy and compliance, particularly in complex edge cases that automated agents alone may not handle effectively.

Customer-Facing API: Once fully validated by both automated agents and human reviewers, the refined, accurate, and compliant data is made available through customer-facing APIs. This step allows end-users—employees, employers, and partners—to access validated data seamlessly, ensuring reliability and trust in payroll outcomes.

The supporting technology stack depicted at the bottom includes:
PydanticAI, Anthropic Claude, ChatGPT (OpenAI): Providing advanced AI-driven language and extraction capabilities.
FastAPI, Python: Enabling robust, scalable, and rapid API-based development.
Supabase, PostgreSQL: Securely storing and managing structured data with high scalability and performance.
Railway, Vercel: Offering seamless, scalable deployment and infrastructure management, facilitating rapid iteration and continuous deployment.

### Expansion of HCM and HR Systems

The embodiments of the present disclosure provide improvements and benefits over conventional systems. With respect to positioning the AI-based payroll processing platform as a central component within a broader HR operations platform, the systems and methods described herein are configured to emphasize the payroll aspect as a pivotal function interconnected seamlessly with other essential HR capabilities, forming an integrated, cohesive HR ecosystem. In some respects, the systems and methods of the present disclosure may be incorporated in the HCM and HR system shown in FIG. 1 and may include one or more of the same or similar components.

FIG. 12 is a diagram illustrating an embodiment of an HR system 160. At the center of the HR system 160, an HR Operations Platform 162 is arranged, serving as a unified hub orchestrating multiple operational functionalities essential to comprehensive human capital management. Surrounding this core platform are various interconnected modules:

Payroll 164: Again, the payroll module may be a fundamental importance (as in FIG. 1) and strategic centrality within the HR operations ecosystem. It leverages AI-driven automation for accurate payroll calculation, compliance management, and reporting, reducing complexity and enhancing employee satisfaction.

HRIS Integration 166: Seamless integration with Human Resource Information Systems ensures consistent and synchronized employee data across all HR processes, enhancing accuracy and efficiency.

Expense Management 168: Efficient handling of employee expenses, integrated directly with payroll to ensure timely reimbursement and accurate financial reporting.

Benefits Marketplace 170: Centralized management of employee benefits enrollment and administration, tightly integrated with payroll to facilitate accurate deduction calculations and regulatory compliance.

Workforce Planning 172: Strategic management of staffing requirements, budgeting, and forecasting, utilizing data insights from payroll and HR analytics to optimize resource allocation.

Onboarding 174: Streamlined processes for integrating new employees into the organization, ensuring immediate synchronization with payroll, benefits, and compliance systems.

Offboarding 176: Efficient management of employee exit processes, including final payroll calculations, benefits adjustments, regulatory compliance, and documentation.

Regulatory Filings 178: Automated compliance management across various jurisdictions, tightly integrated with payroll and benefits administration to ensure timely, accurate filings with regulatory agencies.

Time Tracking 180: Accurate and automated tracking of employee hours, overtime, leave, and attendance data, directly feeding into payroll processes for precise compensation calculation.

Absence Management 182: Systematic management of employee leave requests, approvals, tracking, and integration with payroll, ensuring accurate deductions and compliance with labor regulations.

By emphasizing payroll 164 as a central function, the diagram emphasizes its integration and pivotal role within the wider HR operations infrastructure of the HR system 160. This interconnected design enables comprehensive data sharing, streamlined processes, improved operational efficiency, enhanced compliance, and an elevated employee experience, demonstrating the strategic advantages of embedding the AI-based payroll platform within a larger HR operations platform.

Additionally, it is important to highlight that the core technology underpinning the AI-based payroll platform—referred to as the "LLM Sandwich for Payroll"—has broader applicability across various other domains within the HR Operations Platform. Specifically, this technology can serve as a unified computational framework capable of orchestrating multiple critical HR functionalities beyond payroll, such as benefits administration, time tracking, absence management, onboarding, offboarding, and compliance management. By leveraging the deterministic computational capabilities integrated with probabilistic LLM-based interactions, the "LLM Sandwich" can significantly enhance efficiency, accuracy, and transparency across the entire spectrum of human capital management operations.

### AI-Based Payroll Processing Method

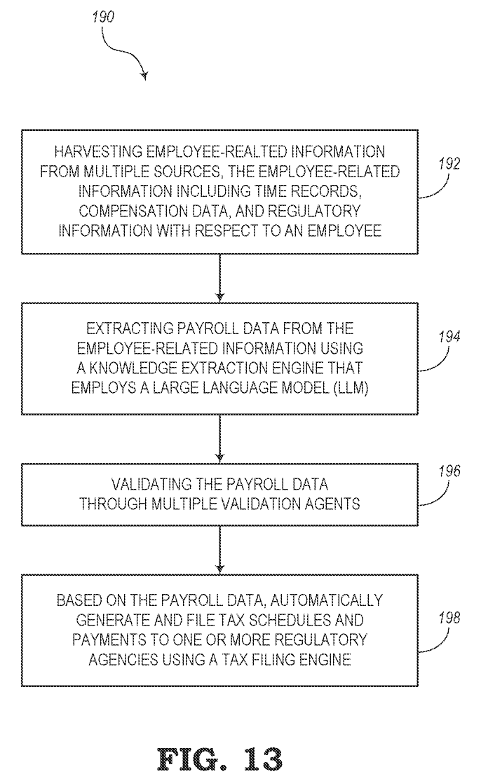

FIG. 13 is a flow diagram illustrating an embodiment of a method 190 for performing automated payroll processing operations, such as by the use of AI. The method 190 includes a step of harvesting employee-related information from multiple sources, as indicated in block 192. The employee-related information, for instance, includes time records, compensation data, and regulatory information with respect to an employee. Also, the method 190 includes a step of extracting payroll data from the employee-related information using a knowledge extraction engine that employs a Large Language Model (LLM), as indicated in block 194. The method 190 further includes a step of validating the payroll data through multiple validation agents, as indicated in block 196. Based on the payroll data, the method 190 also includes a step of automatically generating and filing tax schedules and payments to one or more regulatory agencies using a tax filing engine, as indicated in block 198.

In some embodiments, the multiple validation agents may include a) an Artificial Intelligence (AI) completeness agent that ensures extracted payroll data includes regulatory details for compliance, b) an LLM judge agent that evaluates the logical consistency and accuracy of structured payroll data extracted from natural language regulatory inputs by employing semantic accuracy evaluation, and/or c) a domain-expert agent. Also, in some implementations, the method 190 may further include steps of a) converting the time records to a gross compensation amount using a time-to-gross engine, and b) refining the gross compensation amount to a net amount based on employee-specific deductions using a gross-to-net engine.

The method 190, in some embodiments, may also include steps of a) generating a computational state graph from the validated structured payroll data, and b) executing deterministic payroll calculations using the computational state graph to determine gross pay, applicable taxes, deductions, and net pay. Furthermore, the method 190 may include enabling user interactions through a Natural Language Processing (NLP) LLM interface configured to answer payroll-related queries by retracing stages in the computational state graph. According to some embodiments, the method 190 may further include a step of performing automated verification of payroll calculations using a constraint verification algorithm integrated within the computational state graph. The computational state graph, for example, may include nodes representing sequential payroll calculation procedures including one or more of a) gross pay determination, b) deduction computations, and c) net pay calculations.

According to some implementations, the payroll-related data may include multilingual regulatory documents and global procedural texts to manage payroll regulations based on a location of the employee and a location of an employer. In some embodiments, the method 190 may further include a step of providing real-time updates to one or more of a) the knowledge extraction engine, b) the LLM, and c) the multiple validation agents in response to detected changes in regulatory compliance requirements. The step of validating the payroll data, for instance, may further include human feedback using a Reinforcement Learning with Human Feedback (RLHF) agent to enhance AI model accuracy and reliability.

The step of automatically generating and filing tax schedules and payments (block 198) may also include determining tax obligations at local, state, and federal jurisdictional levels based on executed deterministic payroll calculations. In some embodiments, the method 190 may also include a step of integrating payroll calculations and outcomes into an HR operations platform interconnected with modules for time tracking, absence management, onboarding, offboarding, and benefits management. Also, the method 190, in some embodiments, may include a step of automatically alerting stakeholders to payroll data changes and regulatory updates via notification agents. The employee-related information, according to some implementations, may be harvested from employee portals, employer portals, and partner portals via standardized Application Programming Interfaces (APIs). Furthermore, the method 190 may also include a step of continuously refining AI agent performance through iterative feedback loops involving automated agents and human reviewers.

### Conclusion

Although the present disclosure has been illustrated and described herein with reference to various embodiments and examples, it will be readily apparent to those of ordinary skill in the art that other embodiments and examples may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. An automated method for payroll processing, the automated method comprising steps of:
harvesting employee-related information from multiple sources, the employee-related information including time records, compensation data, and regulatory information with respect to an employee;
extracting payroll data from the employee-related information using a knowledge extraction engine that employs a Large Language Model (LLM);
validating the payroll data through multiple validation agents; and
based on the payroll data, automatically generating and filing tax schedules and payments to one or more regulatory agencies using a tax filing engine.

2. The automated method of claim 1, wherein the multiple validation agents include a) an Artificial Intelligence (AI) completeness agent that ensures extracted payroll data includes regulatory details for compliance, b) an LLM judge agent that evaluates logical consistency and accuracy of structured payroll data extracted from natural language regulatory inputs by employing semantic accuracy evaluation, and c) a domain-expert agent.

3. The automated method of claim 1, further comprising steps of:
converting the time records to a gross compensation amount using a time-to-gross engine; and
refining the gross compensation amount to a net amount based on employee-specific deductions using a gross-to-net engine.

4. The automated method of claim 1, further comprising steps of:
generating a computational state graph from the payroll data; and
executing deterministic payroll calculations using the computational state graph to determine gross pay, applicable taxes, deductions, and net pay.

5. The automated method of claim 4, further comprising a step of enabling user interactions through a Natural Language Processing (NLP) LLM interface configured to answer payroll-related queries by retracing stages in the computational state graph.

6. The automated method of claim 4, further comprising a step of performing automated verification of payroll calculations using a constraint verification algorithm integrated within the computational state graph.

7. The automated method of claim 4, wherein the computational state graph includes nodes representing sequential payroll calculation procedures including one or more of a) gross pay determination, b) deduction computations, and c) net pay calculations.

8. The automated method of claim 1, wherein the employee-related information includes multilingual regulatory documents and global procedural texts to manage payroll regulations based on a first location of the employee and a second location of an employer.

9. The automated method of claim 1, further comprising a step of providing real-time updates to one or more of a) the knowledge extraction engine, b) the LLM, and c) the multiple validation agents in response to detected changes in regulatory compliance requirements.

10. The automated method of claim 1, wherein validating the payroll data further comprises human feedback using a Reinforcement Learning with Human Feedback (RLHF) agent to enhance AI model accuracy and reliability.

11. The automated method of claim 1, wherein automatically generating and filing tax schedules and payments includes determining tax obligations at local, state, and federal jurisdictional levels based on executed deterministic payroll calculations.

12. The automated method of claim 1, further comprising a step of integrating payroll calculations and outcomes into an HR operations platform interconnected with modules for time tracking, absence management, onboarding, offboarding, and benefits management.

13. The automated method of claim 1, further comprising a step of automatically alerting stakeholders to payroll data changes and regulatory updates via notification agents.

14. The automated method of claim 1, wherein employee-related information is harvested from employee portals, employer portals, and partner portals via standardized Application Programming Interfaces (APIs).

15. The automated method of claim 1, further comprising a step of continuously refining AI agent performance through iterative feedback loops involving automated agents and human reviewers.

16. A system comprising:
a processing device, and
a memory device configured to store a computer program having instructions that, when executed, enable the processing device to
harvest employee-related information from multiple sources, the employee-related information including time records, compensation data, and regulatory information with respect to an employee;
extract payroll data from the employee-related information using a knowledge extraction engine that employs a Large Language Model (LLM);
validate the payroll data through multiple validation agents; and
based on the payroll data, automatically generate and file tax schedules and payments to one or more regulatory agencies using a tax filing engine.

17. The system of claim 16, wherein the multiple validation agents include a) an Artificial Intelligence (AI) completeness agent that ensures extracted payroll data includes regulatory details for compliance, b) an LLM judge agent that evaluates logical consistency and accuracy of structured payroll data extracted from natural language regulatory inputs by employing semantic accuracy evaluation, and c) a domain-expert agent.

18. The system of claim 16, wherein the instructions further enable the processing device to:
convert the time records to a gross compensation amount using a time-to-gross engine; and
refine the gross compensation amount to a net amount based on employee-specific deductions using a gross-to-net engine.

19. A non-transitory computer-readable medium configured to store computer logic having instructions that, when executed, cause one or more processing devices to perform steps of:
harvesting employee-related information from multiple sources, the employee-related information including time records, compensation data, and regulatory information with respect to an employee;
extracting payroll data from the employee-related information using a knowledge extraction engine that employs a Large Language Model (LLM);
validating the payroll data through multiple validation agents; and
based on the payroll data, automatically generating and filing tax schedules and payments to one or more regulatory agencies using a tax filing engine.

20. The non-transitory computer-readable medium of claim 19, wherein the instructions further cause the one or more processing devices to perform steps of:
generating a computational state graph from the payroll data;
executing deterministic payroll calculations using the computational state graph to determine gross pay, applicable taxes, deductions, and net pay;
enabling user interactions through a Natural Language Processing (NLP) LLM interface configured to answer payroll-related queries by retracing stages in the computational state graph; and
performing automated verification of payroll calculations using a constraint verification algorithm integrated within the computational state graph,
wherein the computational state graph includes nodes representing sequential payroll calculation procedures including one or more of a) gross pay determination, b) deduction computations, and c) net pay calculations.
